(19) United States
(12) Patent Application Publication
(10) Pub. No.: US 2022/0276378 A1
(43) Pub. Date: Sep. 1, 2022

(54) CONTROL SYSTEM

(71) Applicant: Brose Fahrzeugteile SE & Co. Kommanditgesellschaft, Bamberg, Bamberg (DE)

(72) Inventors: Sergej GAUERHOF, Knetzgau (DE); Florian POHL, Ebersdorf (DE); Matthias GEMPEL, Bamberg (DE)

(73) Assignee: Brose Fahrzeugteile SE & Co. Kommanditgesellschaft, Bamberg, Bamberg (DE)

(21) Appl. No.: 17/626,283

(22) PCT Filed: Jul. 7, 2020
(86) PCT No.: PCT/EP2020/069126

§ 371 Date: Jan. 11, 2022

(30) Foreign Application Priority Data
Jul. 12, 2019 (DE) 10 2019 118 983.7

(51) Int. Cl. G01S 13/931; G01S 13/08; G01S 13/76; G01S 13/86; B60R 25/24; H04W 4/40; H04W 4/80

(52) U.S. Cl. CPC G01S 13/931; G01S 13/08; G01S 13/765; G01S 13/86; B60R 25/245; H04W 4/40; H04W 4/80; G01S 2013/93271; G01S 2013/93272; G01S 2013/93274; B60R 2325/101; B60R 2325/205

(57) ABSTRACT

A control system for actuating a motor vehicle component of a motor vehicle including a positioning system made of multiple positioning units of a first type and multiple positioning units of a second type, and configured to generate positioning information relating to an operator located in the surroundings of the motor vehicle. The positioning system has multiple positioning modules, each positioning module is paired with a separate module installation area, and the positioning modules in each paired module installation area.

### CROSS-REFERENCE TO RELATED APPLICATIONS

This application is the U.S. National Phase of PCT Application No. PCT/EP2020/069126 filed on Jul. 7, 2020, which claims priority to German Patent Application No. DE 10 2019 118 983.7, filed on Jul. 12, 20219, the disclosures of which are hereby incorporated in their entirety by reference herein.

### TECHNICAL FIELD

The present disclosure relates to a control system for operating a motor vehicle component of a motor vehicle.

### BACKGROUND

Vehicles may include a control system that serves in the first place to implement convenience functions for the user of a motor vehicle such as the powered positioning of a tailgate. In very many of these convenience functions, it is important to generate positioning information relating to the user who is located in the surroundings of the motor vehicle. The control system can, for example, detect an approach of the user to a motor vehicle door on the basis of the positioning information, and implement all of the convenience functions associated with this particular motor vehicle door.

### SUMMARY

The present disclosure may be based on the problem of configuring and developing a control system in such a way that the functional scope resulting from the use of different positioning units can be exploited better with optimized use of installation space.

In one or more embodiments, a positioning module provided with two different positioning units is provided. It is assumed here that installation space for one of the positioning units of the positioning module is reserved, and can be used according to the proposal for the further positioning unit. If, for example, a motor vehicle is already fitted with radar sensor units for collision avoidance, the installation space allocated to the radar sensor units can be used at the same time for a Bluetooth wireless unit of extremely small physical size. If, on the other hand, a separate installation space were allocated specifically for the Bluetooth wireless unit, the additional measures required for fastening, electrical connection, or the like would place additional requirements on the installation space required going far beyond the actual dimensions of the Bluetooth wireless unit.

The advantages of the embodiments mentioned above are not, however, only related to installation space. Rather, as a result of merging the two different positioning units, the possibility arises of using sensor information from both positioning units with identical or at least similar reference points. With suitable design, complex conversion calculations between the sensor information of the positioning units can be avoided in this way.

In one or more embodiments, the positioning system may include multiple positioning modules, and a separate module installation area may be allocated to each positioning module, and the positioning modules in the respectively allocated module installation area comprises a positioning unit of the first type and a positioning unit of the second type. The words “separate module installation area” primarily mean that different, self-contained module installation spaces are assigned to each of the positioning modules, in which the components concerned are accommodated. This merging of the positioning unit of the first type with the positioning unit of the second type leads to the advantages explained above in respect of the achievable functional scope of the positioning modules on the one hand, and the reduction of the installation space requirements on the other hand.

The present disclosure describes variants for the design of the positioning unit of the first type and the positioning unit of the second type. In one or more embodiments, the positioning unit of the first type may include a radar sensor unit for generating a distance profile with respect to an associated radar reference point, while the positioning unit of the second type may include a wireless unit for establishing a point-to-point connection with a mobile unit carried by a user.

The combination of these two positioning units working in different ways is particularly advantageous since the radar sensor unit, while it delivers a good distance profile, cannot immediately supply an identification or authentication of the user. Such an identification or authentication is, however, possible by means of the wireless unit with little effort.

The combination of these two positioning units operating in different ways is, however, may be advantageous in that their different acquisition characteristics supplement each other optimally, since, due to the respective radiation characteristic, the radar sensor unit, while it does permit a relatively accurate acquisition of the distance profile, has a range of dead regions in which acquisition is not possible. The distance measurement of the positioning unit of the second type, in this case the wireless unit, can step in here, not having a dead region, but, however, supplying relatively inaccurate distance values.

One or more embodiments may include variants for merging the positioning unit of the first type with the positioning unit of the second type. A variant that is relatively compact and easy to construct from the point of view of control technology is provided, in that the two positioning units are arranged on one and the same circuit board of the positioning module. Care is to be taken here according to the proposal that the radio frequencies of the radar sensor unit on the one hand and of the wireless unit on the other hand are significantly spaced apart from one another, so that no interference results. The advantage of combining a radar sensor unit with a Bluetooth wireless unit shown here, since the radar frequency lies at about 79 GHz, while the Bluetooth frequency lies at about 2.4 GHz.

The two positioning modules can accordingly operate simultaneously. It is, however, also conceivable that the two positioning modules operate with a time offset with respect to one another, in order to totally prevent any mutual influence.

In one or more embodiments, an evaluation arrangement for evaluating the output signals of the two positioning units, is provided. In this case the radar sensor units and the wireless units. The evaluation arrangement can be implemented as a central evaluation arrangement for all the positioning modules. The evaluation arrangement can also, alternatively, comprise individual evaluation units associated with the individual positioning modules.

In yet another embodiment, a further function is assigned to the wireless unit, namely the function of conveying the output signals of the radar sensor unit to the evaluation arrangement, which leads to a compact construction that is simple from the control technology point of view.

According to another embodiment, which has independent significance, a positioning module for a control system according to the proposal is claimed as such.

The consideration of combining a positioning unit of the first type and a positioning unit of the second type by means of a common module housing and/or of a common module carrier and/or of a common supply terminal to form a unified positioning module is central according to the further teaching. The resulting double utilization of the components concerned leads, as above, to a compact construction that is simple from the control technology point of view. Reference may be made to all the explanations about the control system according to the proposal, insofar as they are appropriate, for explaining the positioning module according to the proposal as such.

### BRIEF DESCRIPTION OF THE DRAWINGS

The invention is explained below in more detail with reference to a drawing illustrating just one exemplary embodiment, in which

FIG. 1 shows a plan view of a motor vehicle with a control system according to the proposal.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known control system is provided in EP 3 141 433 B1, which is equipped with a positioning system that may include a positioning unit of a first type, namely a radar sensor unit, and a positioning unit of a second type, namely a Bluetooth unit. It is true that as a result of the use of different positioning units, new possibilities for generating positioning information emerge. In the known control system, however, these possibilities are scarcely exhausted. In addition to this, new challenges in respect of accommodating the components concerned emerge as a result of the use of different positioning units.

Only those components that are required for the explanation of the solution according to the proposal are illustrated in the drawing. The control system 1 according to the proposal serves for operating a motor vehicle component 2 of a motor vehicle 3 in response to an operating action by a user B.

The motor vehicle component 2 can be any operable component of the motor vehicle 3. The control system 1 according to the proposal can in particular serve to operate a plurality of motor vehicle components 2.

As an example, the motor vehicle component 2 is a closing element, in this case a side door. The operation of the motor vehicle component 2 can, accordingly, be the operation of a motor vehicle lock assigned to the closing element or a drive arrangement assigned to the closing element. Other variants of the motor vehicle component 2 include a tailgate, a trunk lid, a rear door, a front hood, an engine hood of the vehicle 3, or the like.

The operating action of the user B that triggers the operation of the motor vehicle component 2 can be defined in different ways. In the simplest case, the operating action can be the adoption of a predetermined relative position of the user B with respect to the motor vehicle 3. The operating action can, however, also be some particular gesture of the user B, in particular a foot movement or the like. The operating action can, finally, relate to a mobile unit yet to be explained. Other variants for the operating action are conceivable.

The control system 1 can be associated with the motor vehicle component 2 in the sense of a decentralized structure. Alternatively, it can also be provided that the control system 1 is a component of a higher-level vehicle control system.

According to the proposal, the control system may include a positioning system 4 consisting of multiple positioning units of a first type 5 and multiple positioning units of a second type 6, and the positioning system 4 is designed to generate positioning information relating to a user B who can be found in the surroundings of the motor vehicle 3.

The positioning information may include information on the relative position of the user B relative to the motor vehicle 3, in particular relative to a reference point 7 associated with the motor vehicle 3. In a first variant, the positioning information relates to the static relative position of the user B relative to the motor vehicle 3. Alternatively or in addition, the positioning information can comprise the dynamic relative position of the user B relative to the motor vehicle 3, since, to a certain extent, the generation of the positioning information involves tracking the user B.

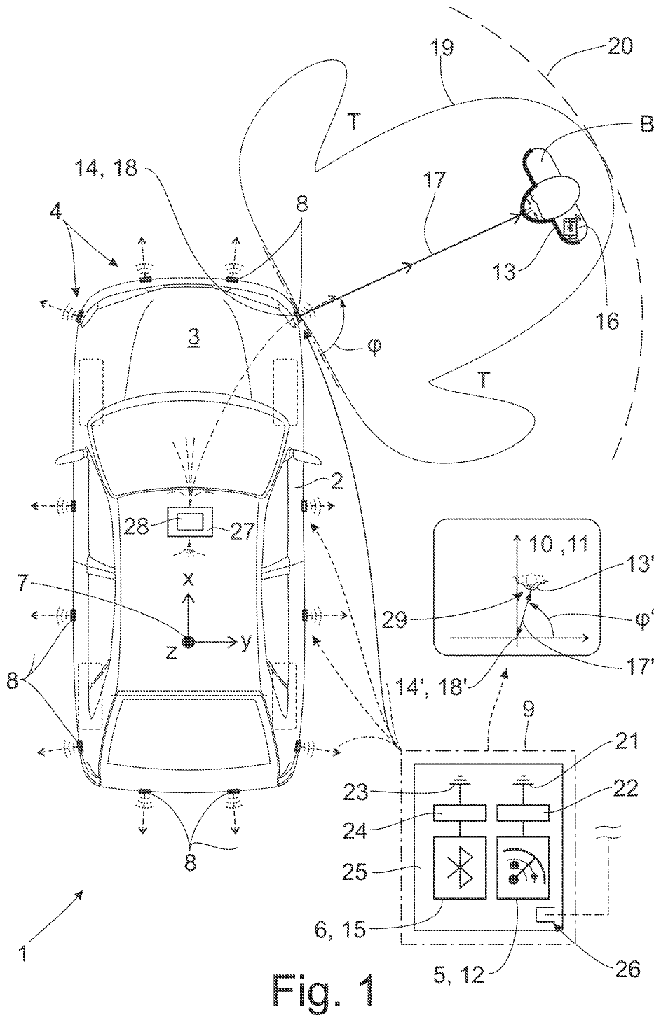

The important point is that the positioning system 4 may include multiple positioning modules 8, and each positioning module 8 is allocated to a separate module installation area 9, and wherein the positioning modules 8 in the respective allocated module installation area 9 comprise a positioning unit of the first type 5 and a positioning unit of the second type 6. Only one of the positioning modules 8 is illustrated in detail in FIG. 1. All the explanations in this respect apply correspondingly to all the other positioning modules 8.

The module installation area 9 allocated to the positioning module 8 can be defined in various ways. As an example, it is the case that the module installation area 9 may be arranged within a spherical volume with a radius of less than 50 cm, or less than 30 cm, or less than 20 cm. The only significant point here is that the module installation spaces 9 are each self-contained and are separated from one another.

In one or more embodiments, the positioning unit of the first type 5 and the positioning unit of the second type 6 operate according to different functional principles. It can, in principle, be provided here that the ways in which the two positioning units 5, 6 work are based on different physical mechanisms. Alternatively, however, it can also be provided that the same physical mechanisms are employed, but that the two positioning units 5, 6 nevertheless operate, in detail, according to different functional principles.

The positioning unit of the first type 5 may generate an output signal 10, while the positioning unit of the second type 6 generates an output signal 11. Both output signals 10, 11, are shown by way of example in the detailed illustration according to FIG. 1.

As an example, the positioning unit of the first type 5 may include a radar sensor unit 12 for generating a distance profile 13′ for a distance curve in relation to an associated radar reference point 14. The distance profile 13 corresponds to the output signal 10 generated by the positioning unit of the first type 5. The positioning unit of the second type 6, on the other hand, may include a wireless unit 15 for establishing a point-to-point connection with a mobile unit 16 carried by the user B, wherein the wireless device 15 is configured to generate a distance value 17′ for the distance 17 relating to the point-to-point connection as its output signal 11. A wireless unit reference point 18 is accordingly allocated to the wireless unit 15 for the definition of the distance value 17′.

The acquisition regions 19, 20 of the positioning unit of the first type 5 and of the positioning unit of the second type 6 for the positioning module 8 illustrated in the upper right of FIG. 1 are illustrated by way of example in FIG. 1. The advantage of combining the two positioning units 5, 6 may be made clear, for example, when considering the dead regions T of the radar sensor unit 12.

In an exemplary embodiment, the radar reference point 14 and the wireless unit reference point 18 are identical to one another. The two reference points 14, 18 are identified as 14′ and 18′ in the illustration of the output signals 10, 11. It can also be seen from the illustration according to FIG. 1 that the distance value 17′ corresponds to the distance 17 between the wireless unit reference point 18 and the mobile unit 16.

The radar sensor unit 12 on the one hand, and the wireless unit 15 on the other hand, can be implemented differently depending on the respectively applicable boundary conditions. As an example, the radar sensor unit 12 may include an antenna module 21 and a preprocessing operation 22 for preprocessing the antenna signals. Alternatively or in addition, it can accordingly be provided that the wireless unit 15 may include an antenna module 23 and a preprocessing unit 24 for preprocessing the antenna signals. The preprocessing of the respective antenna signals may include a simple filtering, a pre-amplification, or the like.

The wireless unit 15 may be configured as a wireless unit that operates according to a short-range wireless standard. In a preferred design, the wireless unit 15 is a Bluetooth wireless unit. In this case it is furthermore advantageously the case that the wireless unit 15 generates the distance value 17′ on the basis of the respective received signal level. As an example, the ascertainment of the distance value 17′ is based on the application of the RSSI (received signal strength indicator) function according to the Bluetooth wireless standard. Other variants for the generation of the distance value 17′ are conceivable.

As suggested further above, different advantageous variants for merging the two positioning units 5, 6 are conceivable. In the simplest case, the two positioning units 5, 6 are arranged immediately adjacent to one another, as is shown schematically in FIG. 1.

FIG. 1 further shows that the positioning module 8 may include a circuit board 25 and at least a part of the first positioning unit 5 and at least a part of the second positioning unit 6 arranged thereon. As an example, a radar chip for the provision of at least a part of the radar sensor unit 12 and a wireless chip for the provision of at least a part of the wireless unit 15, are arranged on the circuit board 25. Alternatively or in addition, the antenna module 21 described above of the first positioning unit 5 and/or the antenna module 23 of the second positioning unit 6 can be arranged on the circuit board 25.

Fundamentally it can be provided that each positioning module 8 may include a module housing with the allocated positioning unit of the first type 5, the allocated radar sensor unit 12, and the allocated positioning unit of the second type 6, the allocated wireless unit 15 arranged therein. Alternatively or in addition it can be further provided that each positioning module 8 may include a module carrier and the allocated positioning unit of the first type 5, the allocated radar sensor unit 12, and the allocated positioning unit of the second type 6, the allocated wireless unit arranged thereon. The above design with a module housing, and the above design with a module carrier, are particularly advantageous in that the positioning modules 8 are implemented as individually manageable modules which, furthermore, may even be preassembled and accordingly pretested.

Another variant for the merging according to the proposal of the two positioning units 5, 6, consists in that each positioning module 8 may include a unified supply terminal 26 for the electrical supply of the first positioning unit 5 and of the second positioning unit 6. This consolidation of the electrical supply of the two positioning units 5, 6 is advantageous from the point of view of installation space, and leads to a particularly simple assembly of the positioning module 8 concerned.

In the illustrated exemplary embodiment, the proposed sensor system 1 may include an evaluation arrangement 27 with at least one evaluation unit for evaluating the output signals of the positioning units 5, 6 of the positioning modules 8, such as the radar sensor units 12 and the wireless units 15 of the positioning modules 8.

As suggested further above, the evaluation arrangement 27 with a single evaluation unit 28 is a central evaluation arrangement 27 for all the positioning modules 8. Alternatively it can be provided that an evaluation unit 28 is allocated to each positioning module 8, which basically corresponds to a decentralized control concept.

The evaluation arrangement 27 may be configured to ascertain position information relating to the user B who is carrying the mobile unit 16 in relation to a predetermined vehicle reference point 7, such as to a predetermined vehicle reference coordinate system, from the output signals 11 of the wireless units 15. A simple triangulation method can be applied here.

In another embodiment, the radar sensor units 12 serve not only to generate the positioning information, but also the detection of collisions, for example while motor-positioning a closing element such as a side door. In detail, the evaluation arrangement 27 and the radar sensor unit 12 of a positioning module 8 are configured to detect a collision that is present and/or imminent on the basis of the distance profile 13′ generated by the radar sensor unit 12.

It is further the case that the evaluation arrangement 27 and the wireless unit 15 of a positioning module 8 may be configured to carry out a wireless-based identification dialog to identify and/or authenticate the wireless unit 15. In this way it is easy to verify that the user B detected by means of the radar sensor unit 12 is an authorized user B with a mobile unit 16.

A design that may be advantageous from the point of view of the identification and/or authentication of the user B consists in that the mobile unit 16 is configured as a mobile telephone, in particular as a smartphone. When starting operation of the motor vehicle 3, the user B registers via a human-machine interface of the motor vehicle 3 using the mobile telephone, and can then be identified or authorized by means of the evaluation arrangement 27.

It has already been pointed out that the two positioning units 5, 6 supplement each other particularly well due to their different functioning principle in respect of the generation of the positioning information. The evaluation arrangement 27 may generate the positioning information for this purpose according to a sensor fusion strategy from the output signals 10 of the first positioning unit 5 and the output signals 11 of the second positioning unit 6. The sensor fusion strategy may be defined to ascertain a correspondence between the distance value 17′ generated by the wireless unit 15 and the distance profile 13′ generated by the radar sensor unit 12, and to derive from this the positioning information relating to the user B. Such a correspondence can, for example, be based on the fact that the distance value 17′ corresponds closely to a corresponding formation 29 in the distance profile 13′ of the radar sensor unit 12. This is shown by way of example in FIG. 1.

As an example, for the case in which correspondence referred to above has been detected, it can be assumed that the above formation 29 can be assigned to the, in particular authorized, user B. The evaluation arrangement 27 may be configured to ascertain outline information relating to the user B from the resulting partial distance profile assigned to the user B. As another example, it is the case that the evaluation arrangement 27 is configured to assign a user class to the user B on the basis of the outline information. The user classes of “user with suitcase”, “user with umbrella” or the like may be named, purely as examples.

Alternatively or in addition, it can be provided that the sensor fusion strategy is defined to check the output signals 10 of the first positioning unit 5 and the output signals 11 of the second positioning unit 6 against one another for plausibility. Particularly high security against an incorrect detection of the user B can be ensured in this way.

As mentioned above, the wireless unit 15 can be used for acquisition of the distance value 17′ and/or for the identification or authentication of the user B. In one or more embodiments, a further function is assigned to the wireless unit 15, in which the output signals 10 of the radar sensor unit 12 are transmitted on a wireless basis to the evaluation arrangement 27. This threefold utilization of the wireless unit 15 leads to a particularly compact construction, and to a simple structure from the point of view of control technology.

Finally, it is yet to be pointed out that the positioning information generated according to the proposal can be used in a variety of ways for operation of the motor vehicle component 2. Preferably this involves the implementation of convenience functions that are handled differently depending on the relative position or relative movement of the user B with respect to the motor vehicle 3. As suggested above, these convenience functions can be the motor-driven unlocking, opening or motor-driven positioning of the motor vehicle component 2, in particular of a closing element such as a side door or a tailgate. Other convenience functions include the activation of vehicle lighting as the user approaches, or the presetting of motor vehicle components such as vehicle seats, exterior mirrors or the like individually for the user. It can, here, in particular be provided that only those motor vehicle components 2 close to which the user B is located or towards which the user B is approaching are operated. The generation of the positioning information according to the proposal is of particular significance to these.

According to a further teaching, which has independent significance, a positioning module 8 as above, with which a positioning unit of the first type 5 and a positioning unit of the second type 6 are consolidated, is claimed as such.

According to the further teaching, the positioning module 8 can comprise a circuit board 25 and at least a part of the first positioning unit 5 and at least a part of the second positioning unit 6 arranged thereon. Alternatively or in addition, the positioning module 8 may include a module housing and the allocated positioning unit of the first type 5 and the allocated positioning unit of the second type 6 arranged therein. Furthermore, alternatively or in addition, it is preferably provided that the positioning module 8 may include a module carrier and the allocated positioning unit of the first type 5 and the allocated positioning unit of the second type 6 arranged thereon. Finally, it is furthermore alternatively or in addition preferably provided that the positioning module 8 may include a unified supply terminal 26 for the electrical supply of the first positioning unit 5 and of the second positioning unit 6. Reference may be made to all the explanations about the control system 1 according to the proposal.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMBERS

1 control/sensor system

2 motor vehicle component

3 motor vehicle

5 first positioning unit

6 second positioning unit

7 vehicle reference point

8 positioning module

12 radar sensor unit

14 radar reference point

15 wireless unit

17 distance

18 reference points

19 acquisition regions

20 acquisition regions

21 antenna module

22 preprocessing operation

23 antenna module

24 preprocessing unit

25 circuit board

26 unified supply terminal

27 evaluation arrangement

28 evaluation unit

29 corresponding formation

13′ distance profile

17′ distance value

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A control system for operating a motor vehicle component of a motor vehicle, the control system comprising:
a positioning system provided with multiple positioning units of a first type and multiple positioning units of a second type, wherein the positioning system is configured to generate positioning information relating to a user disposed in surroundings of the motor vehicle,
wherein
the positioning system includes,
multiple positioning modules, and
a separate module installation area allocated to each positioning module, wherein the multiple positioning modules include a positioning unit of the first type and a positioning unit of the second type.

2. The control system of claim 1, wherein the positioning unit of the first type and the positioning unit of the second type are configured to operate according to different functional principles.

3. The control system of claim 1, wherein the positioning unit of the first type is provided with a radar sensor unit configured to generate a distance profile for a distance curve in relation to an associated radar reference point, wherein the positioning unit of the second type is provided with a wireless unit configured to establish a point-to-point connection with a mobile unit carried by the user, and wherein the wireless unit is configured to generate a distance value for the a distance relating to the point-to-point connection.

4. The control system as claim claim 3, wherein the radar sensor unit and/or the wireless unit includes an antenna module and a preprocessing unit configured to pre-process antenna signals.

5. The control system of claim 1, wherein each positioning module of the multiple positioning modules includes,
a circuit board,
at least a part of a first positioning unit of the multiple positioning units of the first type arranged on the circuit board and
at least a part of a second positioning unit of the multiple positioning units of the second type arranged on the circuit board.

6. The control system of claim 1, wherein each positioning module of the multiple positioning modules includes,
a module housing provided with the positioning unit of the first type, and the positioning unit of the second type, and/or
a module carrier provided with the positioning unit of the first type, and the positioning unit of the second type.

7. The control system of claim 1, wherein each positioning module of the multiple positioning modules includes a unified supply terminal for an electrical supply of the first positioning unit and the second positioning unit

8. The control system of claim 1, further comprising:
an evaluation arrangement provided with at least one evaluation unit configured to evaluate output signals of the positioning units of the first type and the positioning modules of the second type, wherein the evaluation arrangement is configured to ascertain the positioning information relating to the user carrying a mobile unit in relation to a predetermined vehicle reference point.

9. The control system of claim 3, further comprising:
an evaluation arrangement provided with at least one evaluation unit configured to evaluate output signals of the multiple positioning units of the first type and the multiple positioning modules of the second type, wherein the positioning unit of the first type includes a radar sensor unit, and wherein the evaluation arrangement and the radar sensor unit are collectively configured to detect an existing and/or imminent collision based on the distance profile generated by the radar sensor unit.

10. The control system of claim 3, further comprising:
an evaluation arrangement provided with at least one evaluation unit configured to evaluate output signals of the multiple positioning units of the first type and the multiple positioning modules of the second type, wherein the positioning unit of the first type includes a radar sensor unit, and wherein the evaluation arrangement and the wireless unit are collectively configured to carry out a wireless-based identification dialog to identify and/or authenticate the mobile unit.

11. The control system of claim 1, further comprising:
an evaluation arrangement configured to generate the positioning information from a number of output signals of the positioning unit of the first type and a number of output signals of the positioning unit of the second type according to a sensor fusion strategy.

12. The control system of claim 1, further comprising:
an evaluation arrangement configured to ascertain outline information relating to the user from a resulting partial distance profile assigned to the user.

13. The control system of claim 12, wherein the sensor fusion strategy is configured to check a number of output signals of the positioning unit of the first type and a number of output signals of the positioning unit of the second type against one another for plausibility.

14. The control system of claim 3, wherein the wireless unit is configured to wirelessly transmit a number of output signals of the radar sensor unit wirelessly to the evaluation arrangement.

15. A positioning module for a control system comprising:
a circuit board;
at least a part of the first positioning unit arranged on the circuit board; and
at least a part of the second positioning unit arranged on the circuit board, and/or wherein the positioning module further includes,
a module housing and the at least a part of the first positioning unit and the at least a part of the second positioning unit arranged in the module housing, and/or
wherein the positioning module further includes a module carrier and the at least a part of the first positioning unit and the at least a part of the second positioning unit arranged on the positioning module, and/or
wherein the positioning module further includes a unified supply terminal configured for an electrical supply of the first positioning unit and of the second positioning unit.

16. The control system of claim 3, wherein the wireless unit is implemented as a Bluetooth wireless unit configured to generate the distance value based on a received signal level.

17. The control system of claim 5, wherein the at least a part of the first positioning unit is a radar chip and/or a first antenna module, and the at least a part of the second positioning unit is a wireless chip and/or a second antenna module.

18. The control system of claim 1, further comprising:
an evaluation arrangement provided with at least one evaluation unit configured to evaluate a first number output signals of the positioning units of the first type and a second number of output signals of the positioning modules of the second type, wherein the evaluation arrangement is configured to ascertain the positioning information relating to the user carrying a mobile unit in relation to a predetermined vehicle reference coordinate system based on the first number of output signals and the second number of output signals.

19. The control system of claim 11, wherein the sensor fusion strategy is configured to ascertain a correspondence between a distance value generated by the wireless unit and a distance profile generated by the radar sensor unit to derive the positioning information.

20. A control system for use in a vehicle, the control system comprising:
a number of positioning modules each disposed in a number of module installation areas, each module installation area of the number of module installation areas are spaced apart from one another, and the number of positioning modules are collectively configured to generate positioning information of a user disposed within an acquisition region at least partially surrounding the vehicle, wherein each of the positioning modules include,
at least a portion of a radar sensor unit configured to generate a distance profile of a distance curve between the user and a radar reference point, and
at least a portion of a wireless unit configured to establish a point-to-point connection with a mobile unit carried by the user, and generate a distance value based on a distance of the point-to-point connection.
